(19) United States
(12) Patent Application Publication
(10) Pub. No.: US 2004/0159392 A1
(43) Pub. Date: Aug. 19, 2004

(54) Tire building arrangement and method

(75) Inventors: Hubert Ringhoff, Seelze (DE); Wilfried Jordine, Garbsen (DE); Andreas Jungk, Wedemark (DE)

Correspondence Address: GREENBLUM & BERNSTEIN, P.L.C., 1950 ROLAND CLARKE PLACE, RESTON, VA, 20191, US

(73) Assignee: Continental Aktiengesellschaft, Hannover (DE)

(21) Appl. No.: 10/776,269

(22) Filed: Feb. 12, 2004

(30) Foreign Application Priority Data
Feb. 13, 2003 (DE) 103 05 895.8

(51) Int. Cl. B29C 35/00

(52) U.S. Cl. 156/110.1

(57) ABSTRACT

Arrangement and method of building vehicle pneumatic tires. The arrangement has a first production line including a carcass building drum device, a shaping drum device, and a moveable core-centering and carcass-carrying device arranged between the carcass building drum device and the shaping drum device. The moveable core-centering and carcass-carrying device is adapted to receive a carcass from the carcass building drum device and to transfer the carcass the shaping drum device. A second production line includes a movable belt building drum device adapted to build a belt package with at least one belt layer. The movable belt building drum device is adapted to move across the first production line and between the carcass building drum device and the shaping drum device. This Abstract is not intended to define the invention disclosed in the specification, nor intended to limit the scope of the invention in any way.

### CROSS-REFERENCE TO RELATED APPLICATIONS

The present application claims priority under 35 U.S.C. §119 of German Patent Application No. 103 05 895.8, filed on Feb. 13, 2003, the disclosure of which is expressly incorporated by reference herein in its entirety.

### BACKGROUND OF THE INVENTION

1. Field of the Invention

The invention relates to an arrangement and method for building vehicle pneumatic tires.

2. Discussion of Background Information

Known devices for building vehicle pneumatic tires comprise a carcass building drum for building a carcass, a moveable core-centering and carcass-carrying device to receive the prefabricated carcass from the carcass building drum and to transfer the prefabricated carcass provided beforehand with bead cores to a shaping drum, a belt building device with a belt building drum for building the belt package with one or more belt layers, and a shaping drum for joining the prefabricated carcass to the belt package.

The classic production of a new tire by means of such a device is described in detail in column 1, line 47 through column 2, line 58 of the introductory part of document DE 199 18 523 C1.

The carcass building drum, the core-centering and carcass-carrying device and the shaping drum in this order form a first production line along a first axis. This is followed by the belt building device that forms a second production line along a second axis arranged at an angle to the first axis.

Such devices for building vehicle pneumatic tires have the disadvantage that they are structured with a very large surface area and are very extensive. A rapid building of vehicle pneumatic tires is only possible if the belt package is produced on the belt building drum parallel to the production of the carcass on the carcass building drum. Thus, two people are always necessary to operate the device. In such a device the carcass building drum and the belt building drum lie so far apart that the operation of the device (i.e., the control of the application processes) by one person is only possible with reduced machine output. This is because one person would have to cover the great distances between the carcass building drum and the belt building drum. These distances are simply too far for one person to cover. Moreover, the use of one person to operate in such a device renders the tire building process too time-consuming and inefficient.

A tire building device with a carcass production line and a belt production line arranged at a distance therefrom and parallel thereto is known from document DE 199 18 523 C1, the disclosure of which is hereby expressly incorporated by reference in its entirety. The carcass production line comprises two carcass building drums with driving and operating devices and correspondingly assigned assembly or supply devices. Furthermore, the carcass production line comprises a core-centering and carcass-carrying device that is embodied in the carcass production line as movable in a traversing manner. This is followed by the shaping drum. The belt production line comprises a belt building drum with driving and operating devices, which drum can be moved backwards and forwards between two belt coating positions in a traversing manner along an axis arranged parallel to the axis of the carcass production line. A belt-carrying device is arranged in a movable manner between the two production lines. The belt-carrying device takes the belt package from the belt building drum of the belt production line and transports it into the carcass production line. There the belt package is transferred to the shaping drum. Subsequently the belt-carrying device moves back into its original position. The disadvantage with this device for building vehicle pneumatic tires is that the device, as a whole, is structured with a very large surface area, i.e., it takes up a very large amount of area, and functions in a very complicated manner due to the arrangement of three machine axes.

### SUMMARY OF THE INVENTION

The invention provides for a device for building vehicle pneumatic tires with a simpler and more compact structure than that which is known from the prior art. The invention also provides for a device, system and/or arrangement which can be operated by a single person or operator without significantly reducing a machine output when compared with conventional devices that are usually operated by two people.

The device or arrangement of the invention includes two main axes wherein a second axis is arranged between a center line of a carcass building drum and a center line of a shaping drum. The device is a simpler and more compact structure compared with the prior art and can be created in a surprisingly simple manner. Since the belt building drum, according to the invention, is arranged nearer to the carcass building drum, an operation of the device by one person is rendered possible. As noted above, this can be accomplished without the machine output being reduced compared with conventional devices that are usually operated by two people. The invention also provides that one person or operator can control the application processes on the carcass building drum as well as the application processes on the belt building drum.

The invention also provides that the belt building drum of the belt building device is moveable along the second axis into a transfer position of the first axis.

The first axis thus forms a kind of main axis for the travel line of the core-centering and carcass-carrying device. The second axis forms a kind of transverse axis thereto on which the belt building drum with the associated driving and operating device is arranged in a moveable manner. The belt building drum can be moved into different assembly and supply positions at which different belt layers and the tread rubber can be applied. Subsequently, the applied belt package is moved on the belt building drum into the main axis, where it is transferred to another device for further processing (as in known per se). These assembly and supply positions, which require operation or control by one person or operator, are advantageously arranged such that they can be reached quickly by only a single person.

To this end, the second axis is preferably aligned at an angle to the first axis such that the belt building drum is arranged along the second axis in a quickly reachable proximity to the person who operates the carcass building device and controls the application processes on the carcass building drum. Thus, the belt package placed on the belt building drum parallel to the production of the carcass can be controlled by the one person without the machine output having to be reduced.

A further development of the invention provides that the first and the second axis intersect, whereby the belt building drum can be moved into specified belt coating positions. The associated assembly or supply devices can also be arranged on both sides of the first axis. Such an intersection of the machine axes has the advantage that specified belt coating positions, with the associated assembly or supply devices, can be arranged wherever an operation or control by a person is not necessary and where no other arrangement is possible due to the local conditions.

Furthermore, the invention also provides that the belt building drum is moveable into a belt coating position with associated assembly or supply device for tread rubber. The assembly or supply device may also have an automatic tread rubber loading device. This relieves the only person operating the device.

Another advantageous embodiment of the invention provides that the belt building drum can be moved into a belt coating position with an associated assembly or supply device for tread rubber. In this way, the belt coating position can be arranged in a quickly reachable proximity to the person who operates the carcass building device and who controls the application processes on the carcass building drum. The operation and control, during application of the tread rubber on the belt assembly, by only one person is thus improved.

Moreover, the invention also provides for movement scanners which are arranged in the surroundings of the moved parts of the device. Such scanners may provide an emergency stop system for the protection of the operator.

In a further development of the invention, a belt carrier ring can be moved along the first axis for receiving the prefabricated belt package from the belt building drum, for transferring it to a shaping drum, and for removing the green-cover from the shaping drum is provided. A green-cover removal device can also be provided which can move along the first axis. This device can also be moved along the first axis to take over the green-cover from the belt carrier ring. This device can then move along the second axis into a quickly reachable proximity to the person who also controls the application processes on the carcass building drum. The removal of the green-cover by the one person is thus also rendered possible.

The green-cover removal device can also preferably be arranged to swivel about the second axis. It can also be arranged to swivel out of the second axis in the direction of the carcass building drum so that the green-cover can be controlled by the one person. Such an arrangement also allows the green-cover to be removed from the green-cover removal device by hand or by a gripper device.

It has also emerged that the system of intersecting production lines according to the invention can also be advantageously used in the production of pneumatic spring cushions. Thus, the invention contemplates such an arrangement

The invention also provides for an arrangement for building vehicle pneumatic tires wherein the arrangement comprises a carcass building drum device, a shaping drum device, a moveable core-centering and carcass-carrying device adapted to receive the carcass from the carcass building drum device and capable of transferring the carcass to the shaping drum device, and a belt building drum device adapted to build a belt package with at least one belt layer. The carcass building drum device, the core-centering and carcass-carrying device and the shaping drum device form a first production line arranged along a first axis and the belt building drum device forms a second production line arranged along a second axis. The second axis is oriented at an angle to the first axis and the second axis is arranged between the carcass building drum device and the shaping drum device.

The vehicle pneumatic tire may comprise a carcass, a belt package, a tread rubber provided with tread rubber profile, and two tire beads provided with bead cores. The carcass may comprise a prefabricated carcass provided with bead cores. The belt building drum device may form part of a belt building device. The shaping drum may be adapted to join a prefabricated carcass to the belt package. The second axis may be arranged between a center line of the carcass building drum device and a center line of the shaping drum device. The belt building drum device may be adapted to move along the second axis to a transfer position arranged on the first axis.

The angle may comprise a value which allows an operator to efficiently control application processes on the carcass building drum device. The angle may comprise a right angle. The angle may comprise approximately 90 degrees. The angle may be less than 180 degrees. The first axis may intersect the second axis.

The belt building drum device may be adapted to move between first and second belt coating positions.

The arrangement may further comprise at least one assembly or supply device arranged on one side of the first axis.

The arrangement may further comprise a first assembly or supply device arranged on one side of the first axis and a second assembly or supply device arranged on another side of the first axis.

The arrangement may further comprise at least one assembly or supply device arranged on one side of the first axis, wherein the belt building drum device is adapted to move to at least one belt coating position associated with the at least one assembly or supply device. The at least one assembly or supply device may comprise an automatic tread rubber loading device.

The arrangement may further comprise at least one assembly or supply device, wherein the belt building drum device is adapted to move to at least one belt coating position associated with the at least one assembly or supply device and wherein the at least one belt coating position is accessible by an operator.

The arrangement may further comprise at least one scanner device arranged to detect movement. The at least one scanner device may be adapted to effect an emergency stop.

The arrangement may further comprise a belt carrier ring device adapted to transfer the belt package to the shaping drum device. The belt carrier ring device may be capable of receiving the belt package from the belt building drum device. The belt carrier ring device may be capable of transferring the belt package to the shaping drum device. The belt carrier ring device may be capable of receiving a green-cover from the shaping drum device.

The arrangement may further comprise a green-cover removal device adapted to move along the second axis. The green-cover removal device may be adapted to move along the first axis. The green-cover removal device may be adapted to receive the green-cover from the belt carrier ring device. The green-cover removal device may be adapted to move along the second axis to a position which proximate to a working area of a worker. The green-cover removal device may be adapted to swivel relative to the second axis towards a direction of the carcass building drum device, whereby the green-cover can be controlled by the worker and removed from the green-cover removal device. The green-cover may be removable by the worker via one of a worker's hand and a gripper device.

The invention also provides for a method of building vehicle pneumatic tires using the arrangement described above wherein the method comprises transferring portions of a tire to the carcass building drum device arranged adjacent a working area, moving the movable core-centering and carcass-carrying device from an original position towards the carcass building drum device, building a carcass on the carcass building drum device, moving the movable core-centering and carcass-carrying device with the carcass towards the shaping drum device, transferring the carcass to the shaping drum device, moving the movable core-centering and carcass-carrying device away from the shaping drum device to the original position, transferring portions of a tire to the belt building drum device arranged at a first coating position, forming a belt package, moving the belt building drum device from the first coating position along a direction of the second production line to a transfer position, transferring the belt package to a belt carrier ring device and joining the belt package and the carcass on the shaping drum device.

The method may further comprise moving a green-cover removal device along a direction of the second production line into a position on the first production line, transferring a green-cover from the shaping drum device to the green-cover removal device, moving the green-cover removal device with the green cover along a direction of the second production line to a position adjacent the working area, and removing the green-cover from the green-cover removal device.

The invention also provides for an arrangement for building vehicle pneumatic tires, wherein the arrangement comprises a first production line comprising a carcass building drum device, a shaping drum device, and a moveable core-centering and carcass-carrying device arranged between the carcass building drum device and the shaping drum device. The moveable core-centering and carcass-carrying device is adapted to receive a carcass from the carcass building drum device and to transfer the carcass to the shaping drum device. A second production line comprises a movable belt building drum device adapted to build a belt package with at least one belt layer. A working area is arranged proximate the first and second production lines, whereby a worker can access devices on both the first and second production lines. The movable belt building drum device is adapted to move across the first production line and between the carcass building drum device and the shaping drum device.

The first production line may be oriented at an angle which is less than 180 degrees to the second production line. The first production line may be generally oriented at a right angle to the second production line.

The invention also provides for a method of building vehicle pneumatic tires using the arrangement described above wherein the method comprises transferring portions of a tire to the carcass building drum device arranged adjacent a working area, moving the movable core-centering and carcass-carrying device from an original position towards the carcass building drum device, building a carcass on the carcass building drum device, moving the movable core-centering and carcass-carrying device with the carcass towards the shaping drum device, transferring the carcass to the shaping drum device, moving the movable core-centering and carcass-carrying device away from the shaping drum device to the original position, transferring portions of a tire to the belt building drum device arranged at a first coating position, forming a belt package, moving the belt building drum device from the first coating position along a direction of the second production line to a transfer position, transferring the belt package to a belt carrier ring device and joining the belt package and the carcass on the shaping drum device.

The method may further comprise moving a green-cover removal device along a direction of the second production line into a position on the first production line, transferring a green-cover from the shaping drum device to the green-cover removal device, moving the green-cover removal device with the green cover along a direction of the second production line to a position adjacent the working area, and removing the green-cover from the green-cover removal device.

The invention also provides for an arrangement for building vehicle pneumatic tires, wherein the arrangement comprises a first production line comprising a carcass building drum device, a shaping drum device, and a moveable core-centering and carcass-carrying device arranged between the carcass building drum device and the shaping drum device. The moveable core-centering and carcass-carrying device is adapted to receive a carcass from the carcass building drum device and to transfer the carcass to the shaping drum device. The moveable core-centering and carcass-carrying device is movable along a direction of the first production line. A second production line comprises at least one assembly device and a movable belt building drum device adapted to build a belt package with at least one belt layer. The movable belt building drum device is movable along a direction of the second production line and at least between a position adjacent the at least one assembly device and a transfer position generally arranged on the first production line. A working area is arranged proximate the first and second production lines, whereby a worker can access devices on both the first and second production lines. The movable belt building drum device is adapted to move across the first production line and between the carcass building drum device and the shaping drum device.

The invention also provides for a method of building vehicle pneumatic tires using the arrangement described above wherein the method comprises transferring portions of a tire to the carcass building drum device arranged adjacent a working area, moving the movable core-centering and carcass-carrying device from an original position towards the carcass building drum device, building a carcass on the carcass building drum device, moving the movable core-centering and carcass-carrying device with the carcass towards the shaping drum device, transferring the carcass to the shaping drum device, moving the movable core-centering and carcass-carrying device away from the shaping drum device to the original position, transferring portions of a tire to the belt building drum device arranged at a first coating position, forming a belt package, moving the belt building drum device from the first coating position along a direction of the second production line to a transfer position, transferring the belt package to a belt carrier ring device and joining the belt package and the carcass on the shaping drum device.

The method may further comprise moving a green-cover removal device along a direction of the second production line into a position on the first production line, transferring a green-cover from the shaping drum device to the green-cover removal device, moving the green-cover removal device with the green cover along a direction of the second production line to a position adjacent the working area, and removing the green-cover from the green-cover removal device.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

The sole FIGURE shows a diagrammatic overview of the tire building device, arrangement of system according to the invention with a carcass production line along a first axis and a belt production line along a second axis arranged at an angle thereto.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

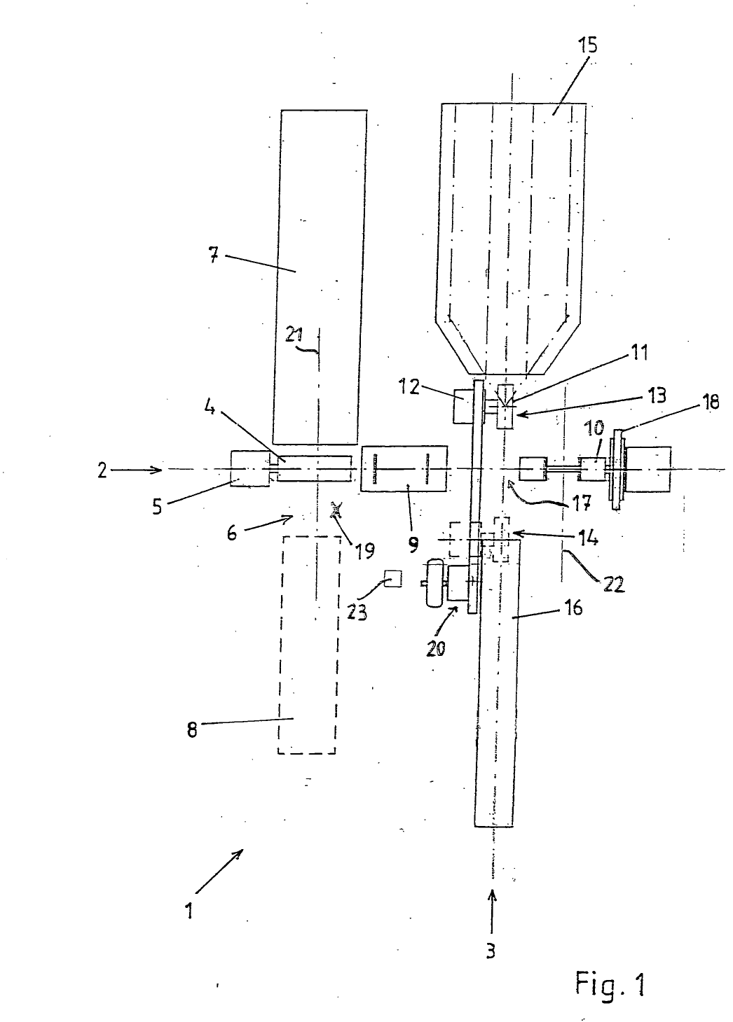

FIG. 1 shows a general view of the tire building device, arrangement or system 1 in plan view. The arrangement 1 includes devices for two production lines. A first production line is arranged along a first axis 2 and a second production line is arranged along a second axis 3. These axes 2, 3 are arranged at an angle to each other such as, e.g., at a right angle or approximately 90 degrees.

The production line arranged along the first axis 2 includes a carcass building drum 4. The carcass building drum 4 is equipped with driving and operating device 5. A moveable core-centering and carcass-carrying device 9 is also arranged along the first axis between the carcass building drum 4 and a shaping drum 10. The shaping drum 10 and a belt-carrying ring 18 are also arranged along the first axis 2. The production line arranged along the second axis 3 includes an assembly device 16, a belt building drum 11 and another assembly device 15. The second axis 3 is arranged between a center line 21 of the carcass building drum 4 and a center line 22 of the shaping drum 10.

The carcass building drum 4 is arranged at a working or coating position or area 6. This area 6 is defined by generally stationary oppositely arranged first and second assembly or supply devices 7 and 8. The first assembly device 7 may contain different conveyor, transfer and transport devices (not shown in detail here). These device preferably transport the inner core or the inner plate of a tire, the sidewalls, and bead-reinforcing profiles (i.e., chafers and which may be provided with textile or metallic strength carriers) to the carcass building drum 4 standing in or arranged within the coating position 6. These devices also transfer them so that a person or operator 19. The operator 19 is working in the area 6 and applies these components and/or control the application processes. After these production stages, these components can be rolled and fixed on the drum circumference via roller and pressure devices (likewise not shown here in further detail). The first stationary assembly device 7 assigned to the coating position 6 may also include (in a similar way) transport, cutting and conveyor devices (not shown here in detail) for transferring the carcass layers made of rubberized textile or metallic strength carriers. The application of these carcass layers can then likewise be carried out and/or be controlled by the person or operator 19 located at the coating position 6. After these stages, the rolling and fixing on the carcass building drum can takes place as described above. The second assembly device 8 assigned to the coating position 6 may also contain in (a similar way) transport, cutting and conveyor devices (not shown here in detail). These devices are preferably used for transferring shoulder pads, the application of which can then likewise take place through and/or be controlled by the person or operator 19 located at the coating position 6. Thereafter, the above noted rolling and fixing on the drum may take place.

The core-centering and carcass-carrying device 9, which is arranged on the first production line, is preferably movable in a traversing manner. Using the device 9, the bead cores which are already provided with fillers can be guided over the carcass building drum 4 in the coating area 6 and positioned there. Subsequently, the carcass building drum 4 can be expanded so that the previously built carcass adheres to the inner side of the cores. Thereafter, the core-centering and carcass-carrying device 9, together with the carcass, moves back towards the shaping drum 10 along the machine axis 2 to an original position and up to and over the shaping drum. The shaping drum 10 then takes over the prefabricated carcass. Then, the shaping drum 10 fixes and prestresses it through a light shaping of the carcass. Subsequently, the core-centering and carcass-carrying device 9 moves back to an original position.

The second production line is arranged along the second axis 3 and includes a belt building drum 11. The belt building drum 11 includes a driving and operating device 12 and is configured to move or traverse back and forth along axis 3 and between a first belt coating position 13 and a second belt coating 14. The second position of the belt building drum 11 is represented by a dotted line.

First and second stationary assembly or supply devices 15 and 16 are assigned to the first and second belt coating positions 13 and 14. These devices 15, 16 can be provided with conveyor and transport devices (not shown in detail here) for transferring the belt components to the belt building drum 11.

The assembly device 15 can convey the belt layers comprising rubberized steel cord layers, if necessary the nylon band (belt band), and the belt buffer strips to the belt building drum 11 located in the first coating position 13. These can be automatically applied.

The belt building drum 11 then moves to the coating position 14 where the application processes can be controlled by the person or operator 19 working in the work area 6. Afterwards, with the aid of the assembly device 16, the tread rubber can be supplied, applied, spliced by hand and mechanically rolled.

The belt building drum 11 can then transport the finished belt package to a transfer position 17 between the first position 13 and the second position 14. The transfer position 17 is aligned with the first production line and is arranged along the first axis 2. There, the belt package is taken over by the belt carrier ring 18 and likewise positioned over the shaping drum 10 and the tire carcass already located there.

The belt building drum 11 is then available again for belt package production.

Once the prefabricated carcass is located on the shaping drum 10 and the belt package is located concentrically over the shaping drum, the latter can be completely expanded. This allows carcass and belt package to be joined together. With the expansion of the carcass, a turning up process can also take place. In this case, the carcass layer ends are folded around the bead cores and the side parts are turned up. This process is preferably carried out with bellows arrangement (not shown here in detail). This bellows arrangement may, if necessary, include a center bellows which expands the center part of the carcass. The arrangement may also include a side shaping bellows, i.e., inflating bellows, that engages axially outside the set cores and that turns up the side parts. The turning up of the side parts can be supported by pressure rings, also known as “pushers”, that (if necessary) can be moved along the first axis 2 and delivered to the prefabricated carcass there. These pressure rings can also move partially over the shaping drum 10.

A green-cover removal device 20 can also be utilized in the arrangement. This device 20 can move along the second axis 3 and along the first axis 2 to take over the green-cover. The green-cover removal device 20 comprises a receiver plate which can swivel towards the shaping drum 10. The belt carrier ring 18, which can move along the first axis 2, can subsequently remove the green-cover from the shaping drum 10 and can transport it to the green-cover removal device 20. Subsequently, the green-cover removal device 20, with the green-cover, can move along the second axis 3 into a quickly reachable proximity to the person or operator 19, who also controls the application processes on the carcass building drum 4. The receiver plate of the green-cover removal device 20 is preferably embodied so that it can be swiveled from the second axis 3 and in the direction of the carcass building drum 4, such that the green-cover can be controlled by the one person or operator 19, and can be removed from the green-cover removal device 20 by hand or through a gripper device.

To protect the person operating the arrangement 1, the invention also provides for movement scanners 23 which may be in the form of, e.g., light barriers. These scanners 23 can be arranged to surround or being the general area of the moving parts or devices. Such scanners 23 are preferably arranged to perform an emergency stop function of the various devices in the arrangement 1 when triggered. In the FIGURE, a box designated with reference number 23 represents one non-limiting arrangement of the movement scanners.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

List of Reference Numbers

| | |
|---|---|
| 1 | Tire building device |
| 2 | First axis |
| 3 | Second axis |
| 4 | Carcass building drum |
| 5 | Driving and operating device |
| 6 | Work and coating position |
| 7 | Assembly or supply device |
| 8 | Assembly or supply device |
| 9 | Core-centering and carcass-carrying device |
| 10 | Shaping drum |
| 11 | Belt building drum |
| 12 | Driving and operating device |
| 13 | Belt coating position |
| 14 | Belt coating position |
| 15 | Assembly or supply device |
| 16 | Assembly or supply device |
| 17 | Transfer position |
| 18 | Belt carrier ring |
| 19 | Person |
| 20 | Green-cover removal device |
| 21 | Center line of the carcass building drum |
| 22 | Center line of the shaping drum |
| 23 | Movement scanner |

What is claimed:

1. An arrangement for building vehicle pneumatic tires, the arrangement comprising:
a carcass building drum device;
a shaping drum device;
a moveable core-centering and carcass-carrying device adapted to receive a carcass from the carcass building drum device and being capable of transferring the carcass to the shaping drum device; and
a belt building drum device adapted to build a belt package with at least one belt layer;
the carcass building drum device, the core-centering and carcass-carrying device and the shaping drum device forming a first production line arranged along a first axis; and
the belt building drum device forming a second production line arranged along a second axis,
wherein the second axis is oriented at an angle to the first axis, and
wherein the second axis is arranged between the carcass building drum device and the shaping drum device.

2. The arrangement of claim 1, wherein the vehicle pneumatic tire comprises a carcass, a belt package, a tread rubber provided with tread rubber profile, and two tire beads provided with bead cores.

3. The arrangement of claim 1, wherein the carcass comprises a prefabricated carcass provided with bead cores.

4. The arrangement of claim 1, wherein the belt building drum device forms part of a belt building device.

5. The arrangement of claim 1, wherein the shaping drum device is adapted to join a prefabricated carcass to the belt package.

6. The arrangement of claim 1, wherein the second axis is arranged between a center line of the carcass building drum device and a center line of the shaping drum device.

7. The arrangement of claim 1, wherein the belt building drum is adapted to move along the second axis to a transfer position arranged on the first axis.

8. The arrangement of claim 1, wherein the angle comprises a value which allows an operator to efficiently control application processes on the carcass building drum device.

9. The arrangement of claim 1, wherein the angle generally comprises a right angle.

10. The arrangement of claim 1, wherein the angle comprises approximately 90 degrees.

11. The arrangement of claim 1, wherein the angle is less than 180 degrees.

12. The arrangement of claim 1, wherein the first axis intersects the second axis.

13. The arrangement of claim 1, wherein the belt building drum device is adapted to move between first and second belt coating positions.

14. The arrangement of claim 1, further comprising at least one assembly or supply device arranged on one side of the first axis.

15. The arrangement of claim 1, further comprising a first assembly or supply device arranged on one side of the first axis and a second assembly or supply device arranged on another side of the first axis.

16. The arrangement of claim 1, further comprising at least one assembly or supply device arranged on one side of the first axis, wherein the belt building drum device is adapted to move to at least one belt coating position associated with the at least one assembly or supply device.

17. The arrangement of claim 16, wherein the at least one assembly or supply device comprises an automatic tread rubber loading device.

18. The arrangement of claim 1, further comprising at least one assembly or supply device, wherein the belt building drum device is adapted to move to at least one belt coating position associated with the at least one assembly or supply device and wherein the at least one belt coating position is accessible by an operator.

19. The arrangement of claim 1, further comprising at least one scanner device arranged to detect movement.

20. The arrangement of claim 19, wherein the at least one scanner device is adapted to effect an emergency stop.

21. The arrangement of claim 1, further comprising a belt carrier ring device adapted to transfer the belt package to the shaping drum device.

22. The arrangement of claim 21, wherein the belt carrier ring device is capable of receiving the belt package from the belt building drum device.

23. The arrangement of claim 22, wherein the belt carrier ring device is capable of transferring the belt package to the shaping drum device.

24. The arrangement of claim 22, wherein the belt carrier ring device is capable of receiving a green-cover from the shaping drum device.

25. The arrangement of claim 24, further comprising a green-cover removal device adapted to move along the second axis.

26. The arrangement of claim 25, wherein the green-cover removal device is adapted to move along the first axis.

27. The arrangement of claim 26, wherein the green-cover removal device is adapted to receive the green-cover from the belt carrier ring device.

28. The arrangement of claim 27, wherein the green-cover removal device is adapted to move along the second axis to a position which proximate to a working area of a worker.

29. The arrangement of claim 28, wherein the green-cover removal device is adapted to swivel relative to the second axis towards a direction of the carcass building drum device, whereby the green-cover can be controlled by the worker and removed from the green-cover removal device.

30. The arrangement of claim 29, wherein the green-cover is removable by the worker via one of a worker's hand and a gripper device.

31. An arrangement for building vehicle pneumatic tires, the arrangement comprising:
a first production line comprising a carcass building drum device, a shaping drum device, and a moveable core-centering and carcass-carrying device arranged between the carcass building drum device and the shaping drum device;
the moveable core-centering and carcass-carrying device being adapted to receive a carcass from the carcass building drum device and to transfer the carcass to the shaping drum device;
a second production line comprising a movable belt building drum device adapted to build a belt package with at least one belt layer; and
a working area arranged proximate the first and second production lines, whereby a worker can access devices on both the first and second production lines,
wherein the movable belt building drum device is adapted to move across the first production line and between the carcass building drum device and the shaping drum device.

32. The arrangement of claim 31, wherein the first production line is oriented at an angle which is less than 180 degrees to the second production line.

33. The arrangement of claim 31, wherein the first production line is generally oriented at a right angle to the second production line.

34. An arrangement for building vehicle pneumatic tires, the arrangement comprising:
a first production line comprising a carcass building drum device, a shaping drum device, and a moveable core-centering and carcass-carrying device arranged between the carcass building drum device and the shaping drum device;
the moveable core-centering and carcass-carrying device being adapted to receive a carcass from the carcass building drum device and to transfer the carcass to the shaping drum device;
the moveable core-centering and carcass-carrying device being movable along a direction of the first production line;
a second production line comprising at least one assembly device and a movable belt building drum device adapted to build a belt package with at least one belt layer;
the movable belt building drum device being movable along a direction of the second production line and at least between a position adjacent the at least one assembly device and a transfer position generally arranged on the first production line; and
a working area arranged proximate the first and second production lines, whereby a worker can access devices on both the first and second production lines,
wherein the movable belt building drum device is adapted to move across the first production line and between the carcass building drum device and the shaping drum device.

35. A method of building vehicle pneumatic tires using the arrangement of claim 1, the method comprising:
transferring portions of a tire to the carcass building drum device arranged adjacent a working area;
moving the movable core-centering and carcass-carrying device from an original position towards the carcass building drum device;
building a carcass on the carcass building drum device;
moving the movable core-centering and carcass-carrying device with the carcass towards the shaping drum device;
transferring the carcass to the shaping drum device;
moving the movable core-centering and carcass-carrying device away from the shaping drum device to the original position;
transferring portions of a tire to the belt building drum device arranged at a first coating position;
forming a belt package;
moving the belt building drum device from the first coating position along a direction of the second production line to a transfer position;
transferring the belt package to a belt carrier ring device; and
joining the belt package and the carcass on the shaping drum device.

36. The method of claim 35, further comprising:
moving a green-cover removal device along a direction of the second production line into a position on the first production line;
transferring a green-cover from the shaping drum device to the green-cover removal device;
moving the green-cover removal device with the green cover along a direction of the second production line to a position adjacent the working area;
removing the green-cover from the green-cover removal device.

37. A method of building vehicle pneumatic tires using the arrangement of claim 31, the method comprising:
transferring portions of a tire to the carcass building drum device arranged adjacent the working area;
moving the movable core-centering and carcass-carrying device from an original position towards the carcass building drum device;
building a carcass on the carcass building drum device;
moving the movable core-centering and carcass-carrying device with the carcass towards the shaping drum device;
transferring the carcass to the shaping drum device;
moving the movable core-centering and carcass-carrying device away from the shaping drum device to the original position;
transferring portions of a tire to the belt building drum device arranged at a first coating position;
forming a belt package;
moving the belt building drum device from the first coating position along a direction of the second production line to a transfer position;
transferring the belt package to a belt carrier ring device; and
joining the belt package and the carcass on the shaping drum device.

38. The method of claim 37, further comprising:
moving a green-cover removal device along a direction of the second production line into a position on the first production line;
transferring a green-cover from the shaping drum device to the green-cover removal device;
moving the green-cover removal device with the green cover along a direction of the second production line to a position adjacent the working area;
removing the green-cover from the green-cover removal device.

39. A method of building vehicle pneumatic tires using the arrangement of claim 34, the method comprising:
transferring portions of a tire to the carcass building drum device arranged adjacent the working area;
moving the movable core-centering and carcass-carrying device from an original position towards the carcass building drum device;
building a carcass on the carcass building drum device;
moving the movable core-centering and carcass-carrying device with the carcass towards the shaping drum device;
transferring the carcass to the shaping drum device;
moving the movable core-centering and carcass-carrying device away from the shaping drum device to the original position;
transferring portions of a tire to the belt building drum device arranged at a first coating position;
forming a belt package;
moving the belt building drum device from the first coating position along a direction of the second production line to a transfer position;
transferring the belt package to a belt carrier ring device; and
joining the belt package and the carcass on the shaping drum device.

40. The method of claim 39, further comprising:
moving a green-cover removal device along a direction of the second production line into a position on the first production line;
transferring a green-cover from the shaping drum device to the green-cover removal device;
moving the green-cover removal device with the green cover along a direction of the second production line to a position adjacent the working area;
removing the green-cover from the green-cover removal device.
